(19) United States
(12) Patent Application Publication
(10) Pub. No.: US 2021/0268881 A1
(43) Pub. Date: Sep. 2, 2021

(54) VEHICLE DISPLAY SYSTEM

(71) Applicant: Westinghouse Air Brake Technologies Corporation, Pittsburgh, PA (US)

(72) Inventors: Karl J. Kobel, Buffalo Grove, IL (US); Werner Malcherek, Dachau (DE); Timothy R. Schmidt, Buffalo Grove, IL (US); Afsar Ali, Buffalo Grove, IL (US)

(21) Appl. No.: 17/276,687

(22) PCT Filed: Sep. 17, 2019
(86) PCT No.: PCT/US19/51539

§ 371 Date: Mar. 16, 2021

Related U.S. Application Data
(63) Continuation of application No. 16/228,951, filed on Dec. 21, 2018, now abandoned.
Application No. 16/228,951 is a continuation of application No. 16/228,989, filed on Dec. 21, 2018, now abandoned.
(60) Provisional application No. 62/732,359, filed on Sep. 17, 2018.
(60) Provisional application No. 62/732,326, filed on Sep. 17, 2018.

(51) Int. Cl. B60J 5/04; G09F 9/35; G09F 9/33

(52) U.S. Cl. CPC B60J 5/0497; G09F 21/048; G09F 9/33; G09F 9/35

(57) ABSTRACT

A vehicle display system includes a controller, a display, and a sensor. The controller is configured to be operably disposed on board a vehicle, and the display is configured to be coupled to the controller and to display information to a passenger of the vehicle. The sensor is configured to be coupled to the controller and to detect the passenger when the passenger is in a predetermined area. The controller is configured to change the information displayed by the display responsive to when the sensor detects the passenger in the predetermined area. The system may also include one or more translucent panels (e.g., for a door or window), with the display being attached thereto. The controller may also be configured to control what information is displayed on the display based on vehicle location, speed, mode of operation, etc.

### CROSS-REFERENCE TO RELATED APPLICATION

This application is a 371 of International Application Serial No. PCT/US19/51539, filed Sep. 17, 2019, which claims priority to U.S. Non-Provisional application Ser. No. 16/228,951, filed Dec. 21, 2018, which claims the benefit of U.S. Provisional Application Ser. No. 62/732,359, filed Sep. 17, 2018; International Application Serial No. PCT/US19/51539 also claims priority to U.S. Non-Provisional application Ser. No. 16/228,989, which claims priority to U.S. Provisional Application Ser. No. 62/732,326, filed Sep. 17, 2018, which are hereby incorporated by reference in their entirety.

### FIELD

Embodiments of the invention relate to vehicles. Other embodiments relate to display systems and door assemblies for vehicles.

### BACKGROUND

Transit vehicles, such as buses or passenger railway cars, include one or more doors that are opened and closed to allow the egress and ingress of passengers. Passengers stand near the doors to board the vehicle and also prior to exiting the vehicle.

There are many different types of displays used to convey various information or to provide entertainment. The following patents disclose various types of displays and are hereby incorporated by reference in their entirety: EP 3066657A1, Transflective TFT Display; DE202016106621U1, TFT Common Backlight; EP 3291214A3, Dual Use Display; EP 3015915, Transparent Display; and DE 202016106906U1, LED Between Glass.

### BRIEF DESCRIPTION

In an embodiment, a vehicle display system includes a controller, a display, and a sensor. The controller is configured to be operably disposed on board a vehicle, and the display is configured to be coupled to the controller and to display information to a passenger of the vehicle. The sensor is configured to be coupled to the controller and to detect the passenger when the passenger is in a predetermined area. The controller is configured to change the information displayed by the display responsive to when the sensor detects the passenger in the predetermined area.

In another aspect, the display system further includes one or more translucent panels configured to be secured to a structure of the vehicle. The display is attached to at least one of the one or more translucent panels, and the predetermined area includes an area within the vehicle, e.g., in front of the one or more translucent panels. For example, the one or more translucent panels may be part of a door assembly of the vehicle, or part of a window assembly of the vehicle.

In another embodiment, a vehicle display system includes a display and a controller. The display is configured to display diagnostic information associated with a vehicle. The controller is configured to receive at least two diagnostic actuation signals from different sources, and responsive to receiving the at least two diagnostic actuation signals according to a designated time metric, control the display to show the diagnostic information on the display. The at least two diagnostic actuation signals include two or more of a designated signal received from a user device, a signal received from a sensor indicative of a passenger detected in a predetermined area by the display, or received vehicle operation data that meets designated vehicle operation criteria.

### BRIEF DESCRIPTION OF THE DRAWINGS

Reference is now made briefly to the accompanying drawings, in which:

FIG. 1 is a view, partially in perspective and partially schematic, of an embodiment of a vehicle display system.

FIG. 2 shows another embodiment of a vehicle display system.

FIG. 3 shows another embodiment of a vehicle display system.

FIG. 4 illustrates an embodiment of a door assembly that is part of, or includes, at least part of a vehicle display system.

FIG. 5 is a schematic view illustrating aspects of a transportation system, relative to an embodiment of a vehicle display system that operates based in part on information relating to the transportation system.

FIGS. 6-9 are cross-sectional views of portions of embodiments of door assemblies and vehicle display systems.

FIG. 10 is a schematic view of an embodiment of a vehicle display system.

FIG. 11 is a schematic view of displayed diagnostic information according to an aspect of the invention.

### DETAILED DESCRIPTION

Embodiments of the invention relate to systems for displaying information to passengers in a vehicle. (The passengers may be vehicle operators, conductors, technicians, or other workers, people being transported in the vehicle, or any other people on board a vehicle.) In one example, a vehicle display system includes a controller (control module), a display, and a sensor. The controller is configured to be operably disposed on board a vehicle, and the display is configured to be coupled to the controller and to display information to a passenger of the vehicle. The sensor is configured to be coupled to the controller and to detect the passenger when the passenger is in a predetermined area. The controller is configured to change the information displayed by the display responsive to when the sensor detects the passenger in the predetermined area.

The display system may further include one or more translucent panels that are configured to be secured to a structure of the vehicle, e.g., as part of a door assembly or a window assembly. In such an embodiment, the display may be attached to one or more of the translucent panels, with the predetermined area including an area within the vehicle, e.g., in front of the one or more translucent panels. In this manner, in the case of a door assembly for example, the controller may control the display to display particular, designated information (e.g., changing from displaying no information to displaying the designated information, or changing from displaying one set of information to displaying a different set of information) when the sensor detects that a passenger has moved to stand in front of the door.

The vehicle may be a transit vehicle (e.g., a bus or railway passenger vehicle), an automobile or other on-road personal-use vehicle, a haul truck or other construction, mining, or agriculture vehicle, a marine vessel, an aircraft, or any other vehicle. In one embodiment, the vehicle is a transit vehicle (e.g., bus or rail passenger car) having relatively large, elongate, translucent doors (e.g., either the entireties of the door panels are translucent, or the doors include translucent panel portions). For example, the vehicle may include at least one door that has at least a designated minimum width and/or height (e.g., for a person standing up to exit the vehicle), where the designated minimum width and/or height may be established according to government or other regulations of the locale where the transit vehicle is designated or intended for use. Such a designated height may be, for example, from 165 cm to 216 cm (65 to 85 inches). In one embodiment, a vehicle includes two such elongate doors that are adjacent to one another and actuated to open and close in concert for providing a common and relatively wide (relative to one such door by itself) opening for vehicle ingress and egress.

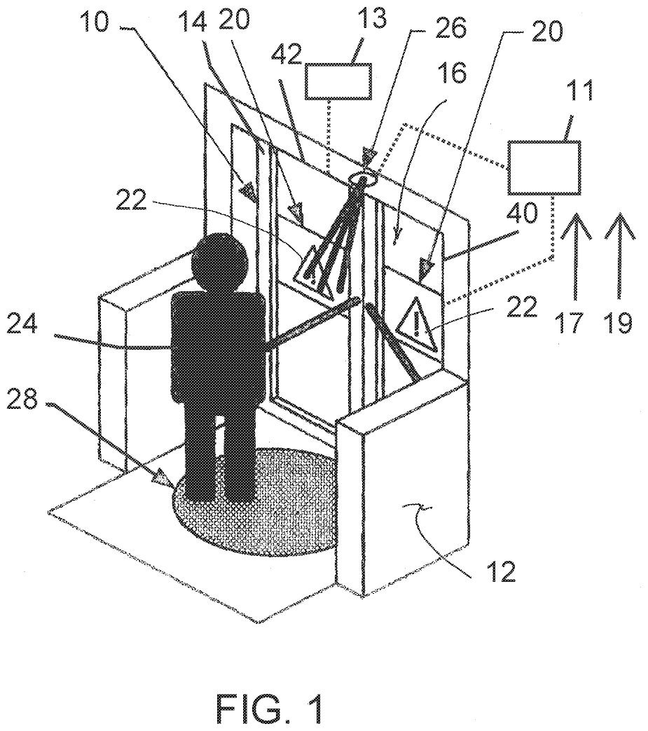

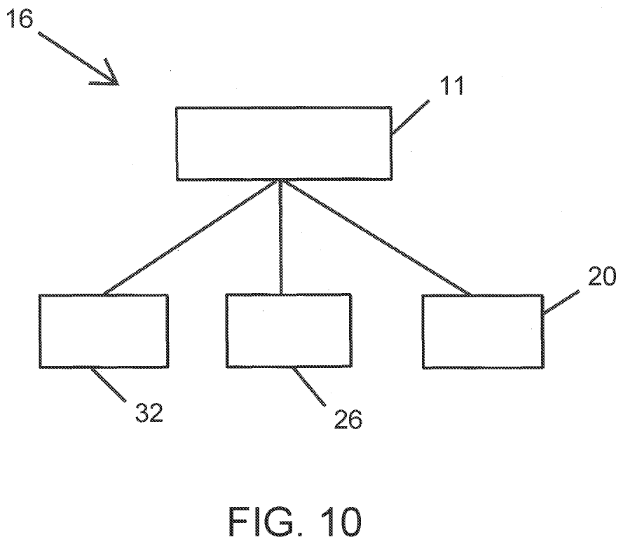

Turning now to FIG. 1 (see also FIG. 10), an embodiment of a vehicle display system 16 for a vehicle 12 includes a controller 11 (also referred to as a control module), a display 20, and a sensor 26. The controller is configured to be operably disposed on board the vehicle 12, e.g., it is configured to be electrically powered by a power source on board the vehicle, and to withstand, for example, shocks and vibrations of the vehicle in operation, at least within a designated use case and lifespan. The controller includes one or more processors or other electronic circuits that, at least in part, receive electrical signals as input (e.g., sensor data signals, operator input and control signals, etc.) and generate electrical signals as output (e.g., control signals for controlling one or more devices on board the vehicle), as a function of program instructions stored in non-transitory memory and/or circuit configuration. The controller may be configured to communicate the signals through or using a communication unit 32, which may be separate from and/or integrated with the controller; the communication unit may include, for example, an I/O bus/interface, a network switch, hub, or other adapter, a wireless unit, cables or other conductors, etc. The display is configured to be coupled to the controller and, under control of the controller, to display information 22 to a passenger 24 of the vehicle. The display is an electronic device that is controllable by the controller for displaying selected/designated information, the content of which may be controllably changed over time, e.g., responsive to vehicle operations, as explained in more detail herein. The display and controller may be integrated together as a unit (e.g., the controller may be a controller that is dedicated for controlling the display), or they may be separate components. For example, the controller may be a controller that is configured to also control other aspects of vehicle operation. The controller may be configured to operate in conjunction with another controller or control unit or processor, e.g., the controller may be dedicated for controlling a display based on signals received from a vehicle control system/unit, or it may be a vehicle controller that is configured to control vehicle movement or other operations (for example) and to also generate signals that are communicated to a display-specific controller that in turn controls the display based on the signals received from the vehicle controller. The sensor is configured to be coupled to the controller (for the sensor to communicate electrical signals to the controller, with a wired and/or a wireless connection) and to detect the passenger when the passenger is in a predetermined area 28. The controller is configured to change the information displayed by the display responsive to when the sensor detects the passenger in the predetermined area. For example, as noted, this may include changing from displaying no information to displaying a first (e.g., designated) set of information, or changing from displaying a first set of information to displaying a different, second set of information, or changing from displaying a set of information to displaying no information. The information displayed in any instance may be static, e.g., text or graphics or pictures that do not change until the controller receives or determines another triggering event (for changing the displayed data), or it may be dynamic, e.g., video or text or graphics or pictures that change over time. For dynamically-displayed information, the controller may be configured to control the display of different sets, types, or categories of dynamically-displayed information responsive to the sensor detecting a passenger in a predetermined area, i.e., one set of displayed information is changed in favor of a different set of dynamically-displayed information. In one embodiment, for example, the controller is configured to control the display to show a first video feed, and responsive to the sensor detecting the presence of a passenger in the predetermined area, to change from displaying the first video feed to a different, second video feed.

In an embodiment, the display system further includes one or more translucent panels 40, 42 that are configured to be secured to a structure (e.g., frame or other part capable of supporting a panel) of the vehicle, e.g., as part of a door assembly 10 or a window assembly. The translucent panel or panels may be glass, polymer, or another planar- or sheet-formed, solid material through which light can pass, e.g., at least to a degree suitable for a transit or other vehicle (such as enabling a passenger to see details of a station external to a vehicle). The panel(s) may be dimensioned and/or otherwise configured (e.g. thickness, selection of material) for use as exterior-facing vehicle window or door panels, e.g., capable of maintaining an interior environment and/or excluding an external environment, such as rain, within designated operational conditions of the vehicle in question, and/or contributing to the structural integrity of the external frame/body of the vehicle, and/or capable of withstanding shocks, vibrations, impact of debris kicked up from the vehicle wheels or otherwise during designated or designed use conditions of the vehicle, etc. Alternatively, the panel(s) may be dimensioned or otherwise configured for use as a vehicle interior window, modesty panel, interior door panel, or otherwise, through attachment to a vehicle structure like a ceiling, floor, chassis, dashboard, etc. In any such embodiments, the display may be attached to one or more of the translucent panels, for example attached to a surface of a panel, sandwiched between two panels that overlay one another, disposed in an interior cavity defined by a single panel, and so on. Attachment mechanisms include adhesives, mechanical fasteners, friction fit, etc. In an embodiment, the display itself includes an integrated glass or polymer screen member, which is in addition to the translucent panel(s) of the vehicle. The display may be manufactured with (and incorporate) at least one of the following technologies: thin-film transistor (TFT) liquid-crystal, organic light-emitting diode (OLED), electronic ink (eINK), vacuum florescent display, thin film electroluminescent (TFEL), liquid crystal (LCD), or light-emitting diode (LED), although other suitable display technologies may also be utilized.

In an embodiment, at least some area/portion of the display is translucent when the display is deactivated and/or when the display is powered and displaying information (e.g., the displayed information is non-translucent or partially non-translucent, while the remainder of the display area is at least partially translucent). If the display is part of a vehicle window or door, this contributes to the extent which the vehicle window or door is usable for seeing through to an exterior of the vehicle, or for seeing through from one interior part of the vehicle to another. In one embodiment, for example, the display is a TFEL display, at least a portion of which is at least partially translucent in one or more modes of operation of the display.

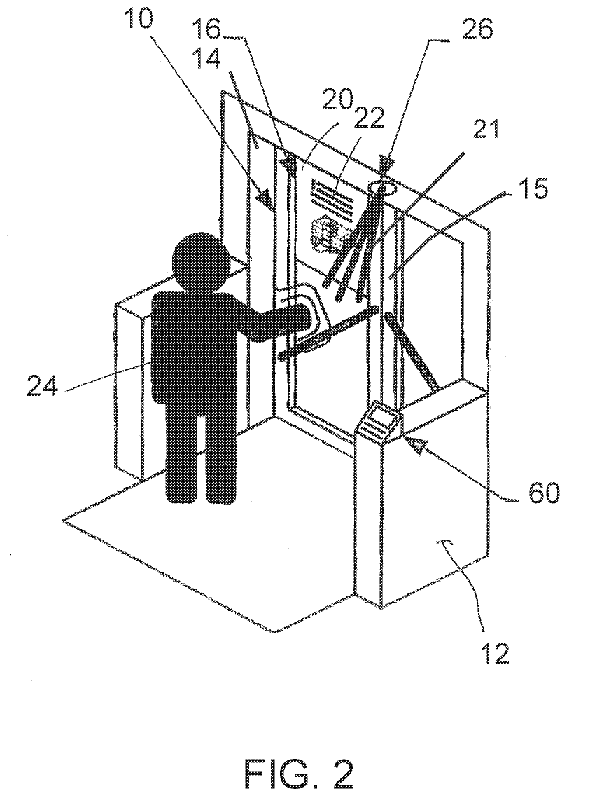

As noted, in operation the sensor 26 is configured to detect a passenger 14 when the passenger is in a predetermined area 28. The sensor may include one or more of the following: a passive infrared (PIR) sensor, a microwave sensor, an ultrasonic sensor, a vibration sensor, a pressure/contact sensor, a camera-based or other optical sensor, or any other suitable sensor configured to detect the position of one or more vehicle passengers. For use, the sensor is attached to a supporting surface of the vehicle, and electrically coupled to the controller. The former may include affixing the sensor external to a door or window frame or other member (e.g., using a mechanical fastener, adhesive, etc.), or it may include the sensor being “built into” or integrated with a vehicle component that also serves some additional purpose. For example, the sensor could be part of (integrated with) a door handle member, a door frame member, etc. The location of the sensor is selected based on the configuration/characteristics of the sensor relative to the predetermined area where it is desired to detect passengers. For example, the predetermined area may be an area in front of a vehicle door in the interior of the vehicle. This may include the area immediately adjacent the door, or it may include an area proximate the door but that excludes an area that the doors traverse when opening or closing. (In this example, a proximate area might include an area extending from a boundary of the area where the doors traverse during opening and closing to a boundary that defines an adjacent area approximately accommodating the space a passenger would occupy if standing by the door for eventual vehicle ingress or egress.) In any such cases, the sensor could be positioned above the door and oriented so that an effective sensor detection region of the sensor coincides with the predetermined area. For example, in one embodiment the sensor comprises an ultrasonic sensor that is configured to emit and receive ultrasonic pulses 21 (see FIG. 2), and to detect changes in the received pulses (e.g., relative to the emitted pulses) indicative of an object having moved into the region in which the ultrasonic pulses are transmitted; here, the sensor is positioned so that the emitted ultrasonic pulses coincide with the predetermined area.

In any of the embodiments herein, the sensor may be configured to automatically detect the presence of a passenger in a predetermined area (that is, without the passenger or any other human operators having to do anything other than the passenger physically entering the predetermined area), and/or without the passenger having to manipulate any physical objects. One example of such a sensor is the aforementioned ultrasonic sensor. Alternatively or additionally, the sensor may be housed in or otherwise associated with a physical object that passengers manipulate, but where the physical object serves a primary purpose other than for detecting the presence of passengers for information display purposes. Examples include a bar, lever, handle, pushbutton, pullcord, pull chain, or other physical (mechanical or electro-mechanical) object that is used to open a door, request opening a door, signal an emergency, request a vehicle stop, etc. In one aspect, this is contrary to having a system that includes a physical/mechanical user input specifically purposed and provided to activate a display for showing information.

In another embodiment, the sensor includes a camera or other optical sensor having a field of view that includes or coincides with the predetermined area, when the sensor is installed in position relative to a predetermined area. Here, the sensor captures light in the field of view either continuously or regularly periodically, and communicates the resulting image data (e.g., periodic still frames or video feed) to the controller. The controller may be configured to compare the image data relative to a baseline (e.g., a stored image file of the field of view of the predetermined area when no passengers are present in the predetermined area), and to determine a passenger is in the predetermined area based on the comparison. For example, if any given set of received image data (e.g., frame or video clip) matches the baseline within designated limits or thresholds, it is deemed that no passenger is present, but if the received image data deviates from the baseline by more than the designated limits or thresholds, it is deemed that a passenger is present. The controller may be configured to account for image variations that are not indicative of passengers, such as changing light or shadow, and/or to analyze the image data (e.g., line or boundary detection, facial detection, etc.) for identifying features designated as being associated with humans.

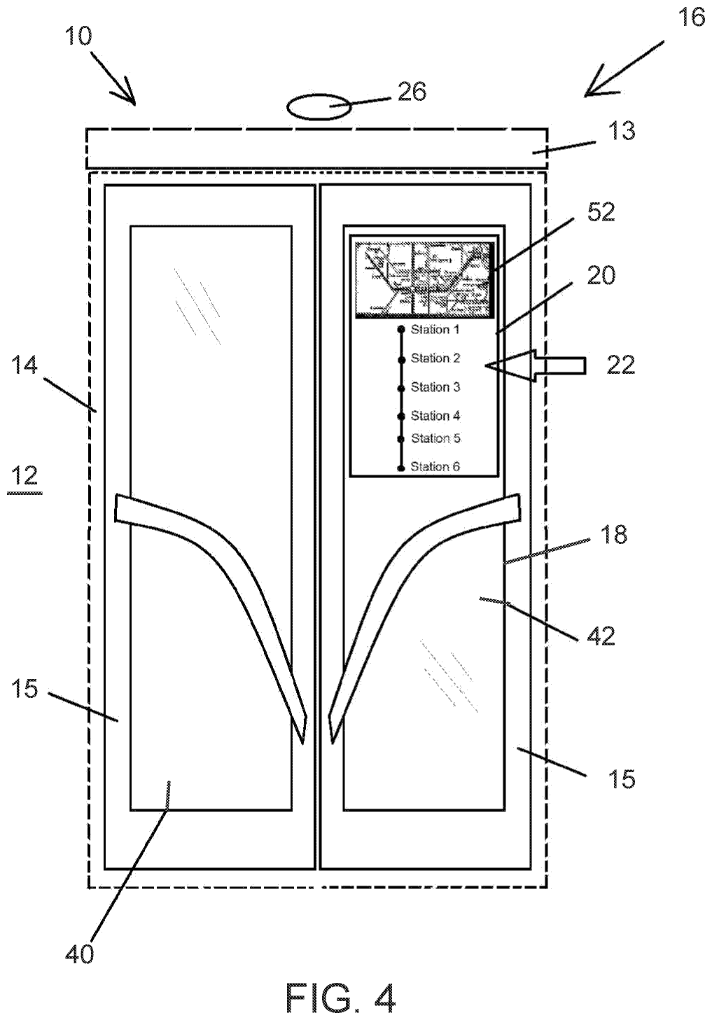

In embodiments, the vehicle 12 includes a door assembly 10 having a door frame 14 and a door actuator 13 coupled to the door frame. The display 20 is configured to be coupled to the translucent panel 40, 42 that is in turn configured to be secured to (attached to) the door actuator or to a door panel support 15 (see FIG. 4) that is coupled to the door actuator. The door frame may be a stationary portion of the door assembly that is attached to a vehicle body or chassis, and which surrounds all or a portion of the periphery of an opening/entryway in the vehicle body or chassis for passenger ingress and egress. The translucent panel (alone or in conjunction with another one or more translucent panels) may comprise the totality of the door panel(s) of the door assembly, that is, the portion of the door assembly that moves for selectively blocking or unblocking the vehicle entryway. Alternatively, as shown in FIG. 4, the door assembly may include one or more door panel supports 15, e.g., non-translucent panel frame assemblies having one or more cutouts or other apertures 18 shaped to receive one or more translucent panels, with the door panel supports and the translucent panels attached thereto together comprising the door panel(s) of the door assembly. For example, the door panel support may be a metal or polymer or composite frame that receives one or more the polymer or glass translucent panels 40, 42 (with a display or displays 20 attached thereto), with the door panel support and translucent panel(s) moving together as a door panel. The door actuator may include a pneumatic, mechanical, and/or electro-mechanical assembly (e.g., motors, gears, actuation rods, etc.) that is controllable (manually, electrically, remotely, automatically, or otherwise) to selectively open and close the translucent panel(s), either alone or if they are attached to one or more door panel supports.

To explain in another way, in embodiments the door assembly includes the door frame, the door actuator, and one or more moveable door panels (for selectively opening and closing a vehicle entryway, e.g., for a standing person to exit or enter the vehicle), where at least one of the one or more door panels is or includes a translucent panel with a display attached thereto, as set forth herein.

In embodiments of the display system, the controller 11 is configured, in operation, to change the information 22 displayed by the display 20 responsive to when the sensor 26 detects the passenger 24 in the predetermined area 28. As mentioned, this may include the controller controlling the display to change from displaying no information to displaying a first set of information (or vice versa), or the controller controlling the display to change from displaying a first set of information to a different, second set of information. Examples of the information that may be displayed include door status or other door information (e.g., a closed indication, an authorized indication, an open request indication, an open indication, a door opening indicator to notify the passenger of the opening door, or safety alerts instructing the passenger to vacate the predetermined area due to the door opening or being about to open), other safety alerts, advertisements, information about restrictions while the vehicle is moving, information about upcoming stations or other stopping locations, other route information (e.g., a transit map), direction or speed or ETA information, information about nearby attractions or amenities, emergency services information, weather information, news, entertainment, transfer information, station exit directions (e.g., go left or right when exiting door for station exit), etc. The controller may also be configured to control the display to change what information is displayed responsive to the sensor detecting that the passenger has vacated the predetermined area. This may include displaying information for at least a designated minimum time period. For example, the controller may be configured to control the display to show a first information set responsive to the sensor indicating a passenger has entered the predetermined area, and to control the display to show a different, second information set responsive to the sensor indicating that the passenger has vacated the predetermined area (and/or that no passengers are in the predetermined area), but to control the display to show the first information set for a designated minimum time period even if the predetermined area is vacated by all passengers prior to the expiration of the designated minimum time period. This avoids an erratic or distracting change in displayed information if passengers enter and vacate the predetermined area frequently.

In embodiments, as relating to passenger detection, the controller is configured to control the display to change the displayed information only responsive to when the predetermined area is vacant and the sensor detects a passenger in or entering the predetermined area, that is, when the sensor detects a passenger entering or having entered a vacant predetermined area. In such a case, the controller would avoid changing the displayed information if a passenger enters the predetermined area when another passenger is already in the predetermined area.

In embodiments, the controller is alternatively or additionally configured to control the display to show information as a function of how many passengers the sensor detects as being in the predetermined area. For example, the controller may be configured to control the display to show a first information set if one passenger is detected in the predetermined area, to control the display to show a different, second information set if two passengers are detected in the predetermined area, and so on. This may include a time delay, e.g., displaying the first information set for a designated minimum time period even if a second passenger is detected in the predetermined area within the time period, and then switching to the second information set. Also, the second information set may include the first information set (having the same content and/or display format), but also additional information not in the first information set. For example, the first information set may remain displayed on one part of the display, while additional information is newly displayed on another part of the display.

In another embodiment, the controller is configured to control the display of an information set on the display based on a length or duration of the information set relative to passengers entering and vacating the predetermined area. For example, the controller may be configured to control the display to show a video clip or segment responsive to the sensor detecting a passenger entering or having entered a vacant predetermined area, and to control the display to show the entire video clip or segment even if the passenger vacates the predetermined area, but to re-start the video clip or segment if the passenger has vacated the predetermined area and responsive to when another passenger enters the re-vacated predetermined area before the video clip or segment has ended.

In another embodiment, the controller 11 is further configured to receive vehicle operation data 17 of the vehicle, and to also change the information 22 displayed by the display 20 based on the received vehicle operation data. The vehicle operation data relates generally to the vehicle in operation. For example, the vehicle operation data may include one or more of current vehicle location, future or planned vehicle location, vehicle speed, whether the vehicle is moving, whether the vehicle is stopped, current vehicle occupancy, an active emergency designation or status, door position or status, designated vehicle mode or status of operation (e.g., “in service” or “not in service”), and so on. The controller may be configured to receive the vehicle operation data from a vehicle operation sensor or sensors, from a vehicle controller (that controls movement of the vehicle), from an offboard sensor, from an offboard dispatch center or repair facility or other remote location, etc. The controller may be configured, for example, to change the information based on and responsive to both the sensor detecting a passenger in the predetermined area and the vehicle data being indicative of a designated vehicle operating condition or mode. For example, the controller may be configured to control the display to change from displaying no information when the vehicle is stopped (regardless of the presence of passengers) to displaying a designated information set/content responsive to the sensor detecting a passenger in the predetermined area when the vehicle is moving. In another aspect, the controller may be configured to receive vehicle operation data that is indicative, sequentially and/or concurrently, of plural vehicle operational modes/aspects that change over time. That is, the modes/aspects in regards to which information is received may change, and/or for plural given modes, the informational values or other content changes over time. An example of the former would be receiving information about location and speed, and then receiving information about vehicle occupancy and door status. An example of the later would be receiving information about vehicle speed and location, where over time both the speed and the location change. Here, the controller may be configured to control the display to show different respective information responsive to each of the vehicle operational modes/aspects.

In one embodiment, for example, the controller is configured to control the display to change from displaying no information (or displaying a first information set) to one of plural designated information sets (i.e., other information sets) responsive to the sensor detecting a passenger in the predetermined area. The controller is further configured to select which of the plural designated information sets is displayed by the display based on received vehicle operation data. For example, the controller may receive vehicle operation data relating to current vehicle speed and current vehicle location, and may assess the vehicle speed to ascertain whether the vehicle is moving or stopped. If the vehicle is stopped, the controller compares the current location to data regarding known stations or other stopping point locations, to determine if the vehicle is stopped at one of the known stations or other stopping point locations. If so, the controller controls the display to show information relating to the station or stopping point where the vehicle is currently located. Examples include displaying information about station or other nearby amenities, station exit directions, local connection or transfer information, and so on. (If the controller determined the vehicle was stopped at a different location, different information associated with that location would be displayed.) On the other hand, if the vehicle is moving, the controller may display different information, such as information about an upcoming station or other upcoming stop, an ETA to the upcoming station or other stop, an advertisement, general transit system information, entertainment programming, and so on. The controller may also be configured to control the display to change what information is shown/displayed based on a comparison of the vehicle operation data to designated thresholds, for example, determining whether the vehicle is traveling above a designated speed or below a designated speed, or to an informational profile, such as a speed profile. For example, displaying an advertisement if the vehicle is traveling above a designated speed (indicative of possibly being in the middle of a transit segment), and switching to displaying information about an upcoming station or other stop responsive to when the vehicle is traveling below the designated speed or below another designated speed (indicative of possibly approaching a station).

To reiterate, in any of the embodiments herein, a controller may be configured to control a display to show information, and to change from showing one designated information set to one of plural other, different designated information sets, based on and/or responsive to both a sensor detecting a passenger in a predetermined area in a vehicle and the content of received vehicle operation data, which includes information about one or more vehicle operational modes or aspects. This may include the possibility of multiple different permutations (of what information is displayed) based on different designated combinations of passenger detection and vehicle operational modes or aspects.

In any of the embodiments herein, the controller may be configured to control the display to show information that is dynamically or concurrently generated based on received vehicle operations data. For example, the controller may control the display to show a current location of the vehicle based on received vehicle operation data indicative of the current location of the vehicle, as soon as possible after the relevant vehicle operation data is received within the operational constraints of the controller (e.g., based on how fast the controller operates and/or the priority of controlling the display relative to other controller operations, if any). Alternatively or additionally, information to be displayed may be static and stored in a memory unit or other storage device. One example is a text or graphic message indicating the name of a station or other designated stop, or a warning-related graphic.

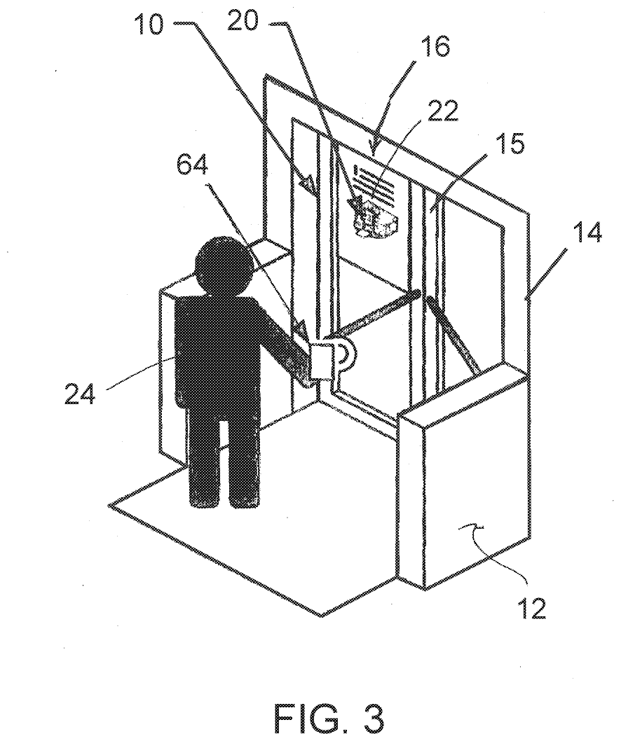

Referring in particular to FIGS. 2-3, the vehicle display system 16 may include a user control 60 configured to allow the passenger 24 to select the information 22 on the display 20. The user control 60 may include one or more of the following: a touch screen, an external keypad, a trackpad, a smart phone or other portable wireless device 64, or any other suitable device or arrangement. The user control 60 may include a camera-based facial expression recognition system or camera-based gesture recognition system, which may be integral with the sensor 26 or formed separately from the sensor 26. The user control 60 may include capacitive sensors configured to recognize touch or gestures. The user control 60 may be configured to be automatically disabled based on predetermined (designated) events. For example, the user control 60 may be disabled in a designated manner (e.g., based on the occurrence of designated conditions) for safety purposes with alerts regarding the disabled user control or restricted actions being provided on the display. The predetermined events may be an upcoming transit stop, a vehicle emergency, police emergency, etc. The user control 60 and display 20 may be configured to allow external content such as advertising or entertainment to be displayed. The content may be responsive to the sensor inputs and user controls previously detailed, such as to display locally relevant content, to browse advertisements, to control entertainment channels, to provide interactive entertainment and ads, or other purposes.

Referring to FIG. 4, the controller may be configured to control the display to show route information 52 of a current route of the vehicle. The controller may determine which particular route information to show based on the current location of the vehicle, e.g., as determined according to the content of received vehicle operation data. The displayed route information may include a static map superimposed with a current location of the vehicle relative to the static map. Alternatively or additionally, the map view may scroll or be otherwise changed or modified over time to show, for example, a more specific or “zoomed in” region through which the vehicle is currently traveling.

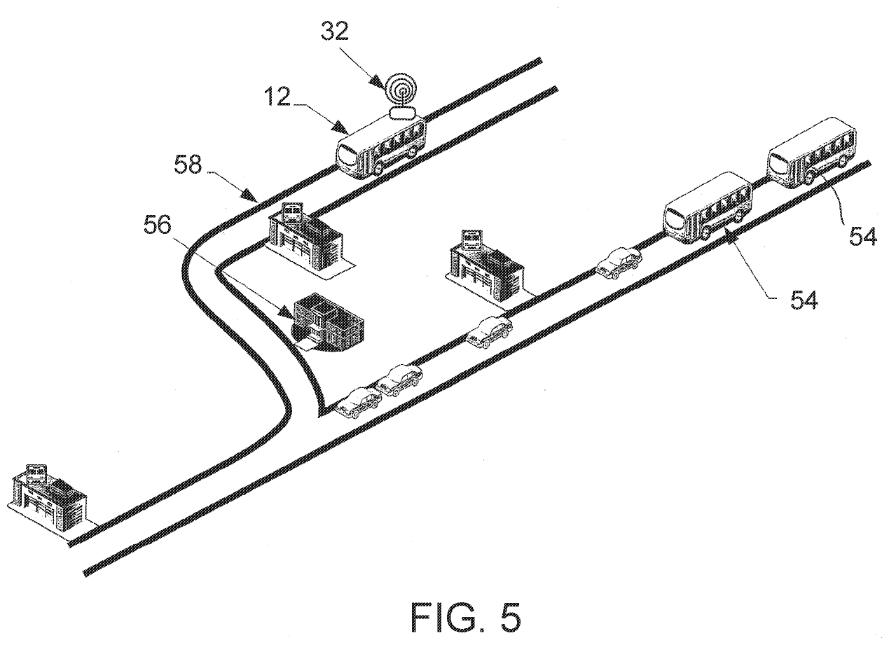

Referring to FIG. 5, the controller may be configured to control the display to show designated information (e.g., a selected set of information that is selected from among multiple different sets of information that are available for possible display) based on the location of the vehicle 12, the position(s) of other vehicles 54 for possible transfers (or otherwise), the location of the vehicle relative to a transit stop 56 or bus depot 58 or other fixed location, etc.

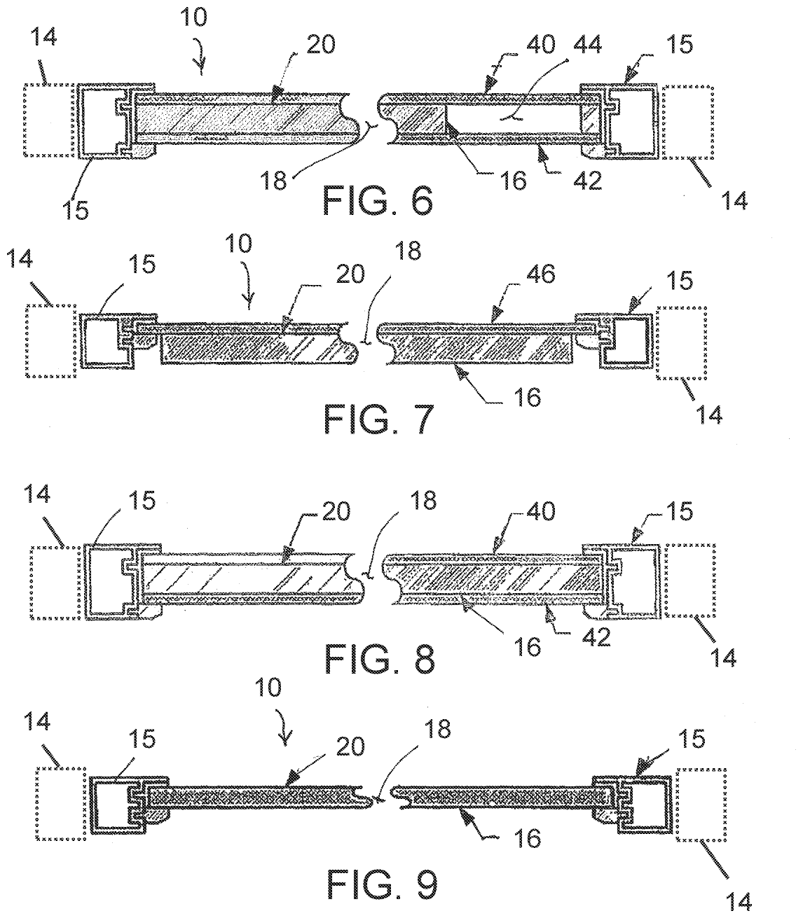

Referring to FIGS. 6 and 8, in one aspect of the present disclosure the door assembly 10 may include a first translucent (e.g., glass or polymer) panel 40 and a second translucent (e.g., glass or polymer) panel 42 each secured to a door panel support 15. (The panels and panel supports together form door panels of the door assembly, and once installed, are disposed in a door frame 14 and operably coupled to one or more door actuators 13.) The display 20 is positioned between the first and second panels 40, 42. As shown in FIG. 6, the display 20 may only occupy a portion of a space 44 between the first and second panels 40, 42. As shown in FIG. 8, the display 20 may entirely occupy the space 44 between the first and second panels 40, 42.

Referring to FIG. 7, in one aspect, the door assembly 10 may include a single translucent panel 46 secured to the door panel support 15 with the display 20 secured to the panel 46.

Referring to FIG. 9, according to one aspect, the display 20 may include an integrated, rigid, planar support (e.g., at least some electronics of the display that are electrically controllable to display information are permanently affixed to the support or are otherwise incapable of being detached from the support without specialized equipment), and, in at least one mode of operation, may be at least partially translucent. In one embodiment, the display is received within the opening 18 of a door panel support 15 and is secured to the door panel support, without the presence of a separate translucent panel. The display 20 being transparent or partially transparent (or otherwise at least partially translucent) allows the passenger 24 to view the information on the display 20 while still being able to at least partially view objects on the opposite side of the display 20. The display 20 may be configured to impose a limit on the visibility or transparency, which is pre-programmed or selected by an operator or other passenger or otherwise.

In any of the embodiments herein, the controller may be further configured to control a display to show diagnostic information (i.e., the displayed information 22 includes diagnostic information) responsive to receipt of at least one diagnostic actuation signal 19. For example, the controller may be configured to receive plural different signals, and to assess each signal to determine if the signal meets criteria for enabling or actuating the display of diagnostic information on a display; if no such signals are received, the controller may be configured to prohibit the display of, and/or not control the display to show, diagnostic information. The diagnostic information may include information about the vehicle generally (e.g., engine or motor condition, information about required or recommended maintenance, and so on), information about a door assembly to which the display is attached (e.g., door condition, information about required or recommended door maintenance, and so on), a system status (e.g., a normal indicator, a warning indicator, a fault indicator, etc.), operational counts and operating times, current faults and warnings, historical faults and warnings, troubleshooting guides, component documentation, or the like. The diagnostic information displayed at any one time may be for one vehicle component or system or sub-system, and/or diagnostic information for multiple such components or systems or sub-systems may be displayed concurrently on a single display (or on multiple displays). The diagnostic actuation signal or signals may include: received vehicle operation data indicative of designated vehicle operational modes or aspects where it is acceptable or permitted to display diagnostic information (e.g., the system is configured to permit the display of diagnostic information when the vehicle is designated as “out of service,” or when the vehicle location corresponds to the location of a service depot or other service location, or when a current time of day or vehicle location is indicative of the vehicle being out of service, or when the vehicle operational information indicates a vehicle maintenance problem or condition potentially requiring the immediate display of vehicle diagnostic information, etc.); a designated signal received from a dispatch center, maintenance depot or repair facility, or other designated off-board location; a designated signal (e.g., encoded signal, or a signal embedded with a designated code, or a signal otherwise having a designated format or content) received from a user control 60, display control panel, or other display activation unit or sub-system; a sensor 26 detecting a passenger (e.g., technician) in a predetermined area, as explained above; or the like. In this example, the user control may be controlled by a maintenance technician (for example), such that diagnostic information is only displayed when the maintenance technician controls the user control in a designated manner to generate the signal indicative of authorized access for displaying diagnostic information on a display. The user control may be, for example, a smart phone or other handheld wireless device carried by a technician, which is configured to generate and transmit wireless signals having a content and/or format that the system 16 recognizes as being associated with an authorized user for diagnostic display purposes.

In one embodiment, the controller (at least in certain modes of operation) is configured to only display diagnostic information on a display responsive to both receipt of vehicle operation data indicative of vehicle operational modes/aspects where it is acceptable or permitted to display diagnostic information and receipt of a diagnostic actuation signal from an authorized off-board location or on-board user control. In another embodiment, the controller (at least in certain modes of operation) is configured to only display diagnostic information on a display responsive to both the sensor detecting the presence of a passenger (e.g., technician) in a predetermined area by the display and receipt of a diagnostic actuation signal from an authorized off-board location or on-board user control. In another embodiment, the controller (at least in certain modes of operation) is configured to only display diagnostic information on a display responsive to both receipt of vehicle operation data indicative of vehicle operational modes/aspects where it is acceptable or permitted to display diagnostic information and the sensor detecting a passenger (e.g., technician) in a predetermined area by the display. In another embodiment, the controller is configured to control the display to show diagnostic information responsive to when all three conditions are met (sensor detection, vehicle operation data meeting designated criteria, and receipt of a signal from a user device or display activation unit or sub-system that is configured to generate signals for diagnostic display actuation).

The controller may be configured to assess the diagnostic display actuation criteria (e.g., sensor detection, vehicle operation data, and/or signal receipt from a user device or the like) relative to a time metric (designated time-related criterion or criteria), e.g., such that the two or three criteria have to be met or present concurrently, or within a designated time period of one another. For example, the controller may be configured to control a display to show diagnostic information responsive to both sensor detection and receipt of a designated signal from a user device within “X” seconds of the sensor detection, where X is a real number greater than zero.

Thus, for example, in an embodiment, a vehicle display system includes a display and a controller, e.g., the controller is electrically connected to the display, and both are configured to be operably disposed on board a vehicle. The display is configured to display diagnostic information associated with the vehicle. The controller is configured to receive at least two diagnostic actuation signals from different sources, and responsive to receiving the at least two diagnostic actuation signals according to a designated time metric (e.g., concurrently or within a time window), control the display to show the diagnostic information on the display. The at least two diagnostic actuation signals include two or more of a designated signal received from a user device, a signal received from a sensor indicative of a passenger (e.g., technician or other person) detected in a predetermined area by the display, or received vehicle operation data that meets designated vehicle operation criteria. In another embodiment, the display of diagnostic information is enabled responsive to the controller receiving all three signals (e.g., user device, sensor, and vehicle operation data) according to a time metric (e.g., within a designated time period).

In embodiments, the controller is configured to control the display to show selected diagnostic information responsive to receipt of signals that are generated from user manipulation of a user interface (e.g., smart phone interface, keypad, touch pad, touch-sensitive screen, etc.) That is, once the display is actuated or authenticated for displaying diagnostic information, the user can select which diagnostic information, out of a greater set or selection of available diagnostic information, is presently shown on the display. This may include the controller being configured to control the display to show menus or other selections of available diagnostic information, e.g., available categories or types of diagnostic information.

In embodiments, display of diagnostic information may be actuated or enabled by the controller based on vehicle location. In one example, the display of diagnostic information may be actuated or enabled based on the location of the vehicle relative to a geo-fence, e.g., a designated boundary associated with a geographical area. For example, the geo-fence may define the boundary of a maintenance depot, maintenance yard, or other location, where the controller is configured to enable/actuate the display of diagnostic information only if the vehicle is within the geo-fence associated with the depot, yard, or other location (e.g., reaches a predetermined distance from the location). Geo-fence information may be stored in a memory of the controller, and vehicle location may be determined (for example) using a GPS sensor/system on board the vehicle.

In another embodiment, the controller is configured to control enabling or actuation of displayed diagnostic data based on or responsive to the location of a user control, e.g., smart phone or other handheld wireless device, relative to the display, as detected by a sensor 26 or based on signals transmitted from the user control or otherwise. For example, diagnostic information may be displayed only if the user control is within a designated distance threshold of the display.

According to one aspect, restricting the display of diagnostic information may be limited to displays that are intended or positioned to be viewed by the public (or other segments of the population), in recognition that it might be undesirable to show such information to persons who may not understand it or may interpret it or use it in an undesired manner.

In an embodiment, the controller is configured to control the display (or displays) to show multiple vehicle component, system, or sub-system status indicators, as part of the diagnostic information, e.g., normal indicators, warning indicators, and fault indicators. Each normal indicator may be displayed in a first color (e.g., green), the warning indicator may be displayed in a second color (e.g., yellow), and the fault indicator may be displayed in a third color (e.g., red), where the first color, the second color, and the third color are each a different color relative to one other. The status indicators may be displayed, as applicable, relative to (e.g., superimposed on) a schematic or graphic of the vehicle that is concurrently displayed on the display.

Diagnostic information may be stored locally, uploaded locally, uploaded remotely, provided or received via a network or other communication connection, etc. The controller may be configured to determine or generate diagnostic information based on received vehicle operation information. In one embodiment, the controller is configured to receive diagnostic information from another on board or off board controller or control system or other system, such as vehicle control unit that controls engine operation, vehicle movement, or the like, or from a repair facility or maintenance depot.

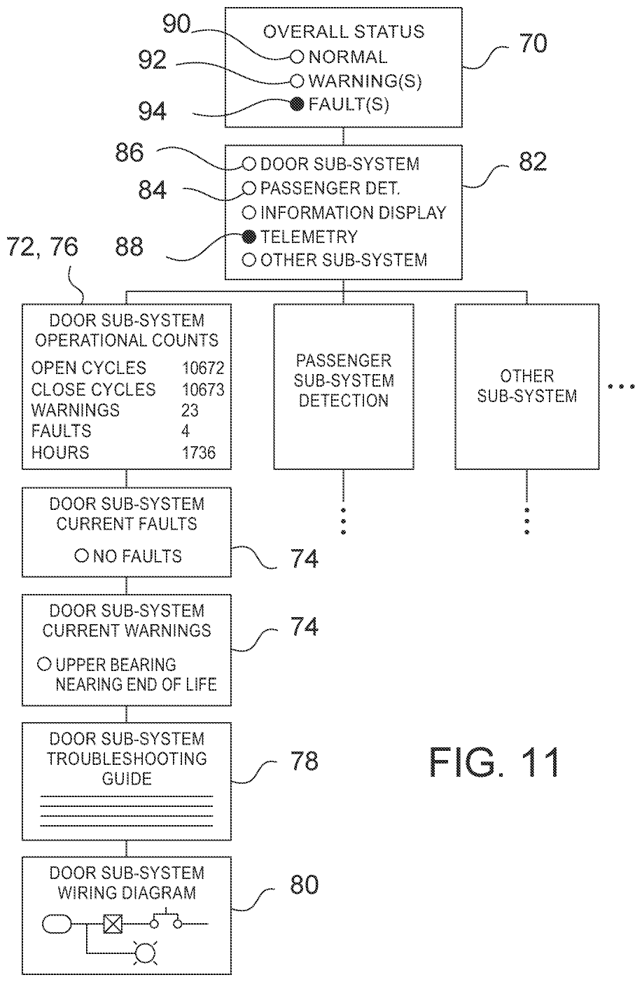

As an example, FIG. 11 shows a schematic view of various aspects of displayed diagnostic information. Here, the displayed diagnostic information includes an overall system (e.g., vehicle) status 70 (e.g., a normal indicator 90, a warning indicator 92, or a fault indicator 94), operational counts and operating times 72, current faults and warnings 74, historical faults and warnings 76, a troubleshooting guide 78, component documentation 80, and a respective sub-system status 82 for each of plural vehicle sub-systems, each displayed relative to a respective status indicator (e.g., a normal indicator 84, a warning indicator 86, or a fault indicator 88).

In an embodiment, a computer-implemented method for displaying diagnostic information on a display of a vehicle includes the steps of: determining with at least one processor whether a display signal was received from a display actuation sub-system; and displaying the diagnostic information on a display. The diagnostic information includes one or more of a system status, operational counts and operating times, current faults and warnings, historical faults and warnings, a troubleshooting guide, and/or component documentation.

In another embodiment of the method, the display actuation sub-system includes a sensor, and the method further includes detecting a presence of a person on the transit vehicle and generating the display signal.

In another embodiment of the method, the display actuation sub-system includes a location-based sensor, and the method further includes detecting a location of the transit vehicle and generating the display signal based on the location of the transit vehicle.

In another embodiment of the method, the method further includes detecting the location of the vehicle relative to a geo-fence.

In another embodiment of the method, the display actuation sub-system includes a first communication module on the transit vehicle and a second communication module at a repair facility, and the method further includes enabling communication between the second communication module and the second communication module to send the display signal.

In another embodiment of the method, the display actuation sub-system includes a smart phone, and the method further includes detecting a location of the smart phone and generating the display signal based on the location of the smart phone.

In one aspect, a door assembly for a vehicle (e.g., a transit vehicle) includes a door frame and a vehicle door display system including a display configured to display information to a vehicle passenger and a sensor configured to detect the vehicle passenger when the vehicle passenger is in a predetermined area. The display is configured to change the information when the sensor detects a passenger in the predetermined area. The door assembly may include a first glass panel and a second glass panel each secured to the door frame, with the display of the vehicle door display system positioned between the first and second glass panels. The display may only occupy a portion of a space between the first and second glass panels. Alternatively, the display may entirely occupy a space between the first and second glass panels. In another embodiment, the door assembly may include a glass panel secured to the door frame, where the display is secured to the glass panel. The door frame may define an opening, where the display is transparent and received within the opening and secured to the door frame.

The vehicle door display system may further include a communication module configured to receive the information. The communication module may be configured to display near real-time information on the display. The information may include one or more of a vehicle state, a door status, local attractions, route information, safety alerts, or advertisements. The door status may include a closed indication, an authorized indication, an open request indication, an opening indication, and/or an open indication.

The vehicle door display system may include a user control configured to allow a passenger to select the information on the display. The user control may include a touch screen, an external keypad, a trackpad, or smart phone or other handheld wireless device. The user control may include a camera-based facial expression recognition system or a camera-based gesture recognition system. The user control may include capacitive sensors configured to recognize touch or gestures. The user control may be configured to be automatically disabled based on the occurrence of predetermined/designated events.

As noted, in embodiments, components of the system may communicate wirelessly. This may include cellular communications, dedicated or special-purpose radios, wireless local area network devices, infrared or other optical communications, utilizing wireless communication devices that are also used for other purposes (such as vehicle control or coordinated vehicle control among plural vehicles), etc.

Although embodiments have been illustrated as having one sensor for detecting a passenger in a predetermined area, in other embodiments there may be multiple sensors associated with a given display or displays, in different locations and/or different types of sensors (that is, sensors that use different technologies or means to detect people in predetermined areas). For example, relative to a predetermined area, there may be a first sensor positioned in a first location, and a second, different type of sensor positioned in a second location.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A vehicle display system comprising:
a controller configured to be operably disposed on board a vehicle;
a display configured to be coupled to the controller and to display information to a passenger of the vehicle; and
a sensor configured to be coupled to the controller and to detect the passenger when the passenger is in a predetermined area, wherein the controller is configured to change the information displayed by the display responsive to when the sensor detects the passenger in the predetermined area.

2. The system of claim 1, further comprising one or more translucent panels configured to be secured to a structure of the vehicle, wherein the display is attached to at least one of the one or more translucent panels, and the predetermined area includes an area within the vehicle in front of the one or more translucent panels.

3. The system of claim 2, wherein the controller is further configured to receive vehicle operation data of the vehicle, and to also change the information displayed by the display based on the received vehicle operation data.

4. The system of claim 3, wherein the vehicle operation data is indicative of plural vehicle operational modes that change over time, and the controller is configured to control the display to show different information responsive to each of the plural operational modes.

5. The system of claim 4, wherein the plural operational modes include one or more of the vehicle moving, the vehicle stopped, the vehicle moving above a first speed threshold, the vehicle moving below a second speed threshold, a location of the vehicle, or a designated operational status of the vehicle.

6. The system of claim 5, wherein the controller is further configured, responsive to receipt of at least one diagnostic actuation signal, to control the display for the displayed information to include diagnostic information.

7. The system of claim 2, wherein the controller is further configured, responsive to receipt of at least one diagnostic actuation signal, to control the display for the displayed information to include diagnostic information.

8. The system of claim 2, wherein the structure comprises a door assembly having a door frame and a door actuator coupled to the door frame, and wherein the one or more translucent panels are configured to be secured to the door actuator or to a door panel support that is coupled to the door actuator, the door actuator configured to move the one or more translucent panels for ingress and egress of the vehicle, and wherein the sensor is configured to be coupled to the door assembly or to the vehicle above or to the side of the door assembly.

9. The system of claim 8, wherein the controller is further configured to receive vehicle operation data of the vehicle, and to also change the information displayed by the display based on the received vehicle operation data, and wherein the vehicle operation data is indicative of plural vehicle operational modes that change over time, and the controller is configured to control the display to show different information responsive to each of the plural operational modes.

10. The system of claim 9, wherein the plural operational modes include one or more of the vehicle moving, the vehicle stopped, the vehicle moving above a first speed threshold, the vehicle moving below a second speed threshold, a location of the vehicle, or a designated operational status of the vehicle.

11. The system of claim 10, wherein the controller is further configured to control the display for the displayed information to include diagnostic information, responsive to receipt of at least one diagnostic actuation signal.

12. The system of claim 8, wherein the controller is further configured, responsive to receipt of at least one diagnostic actuation signal, to control the display for the displayed information to include diagnostic information.

13. The system of claim 8, wherein the display is at least partially translucent.

14. The system of claim 2, wherein the one or more translucent panels comprise a first translucent panel and a second translucent panel overlaying the first translucent panel, and the display is sandwiched between the first and second translucent panels.

15. The system of claim 2, wherein the information comprises one or more of a vehicle state, a door status, local attraction information, route information, safety alerts, directions, or advertisements.

16. The system of claim 2, further comprising a user control configured to be operably coupled with the controller, wherein the controller is configured to change the information displayed by the display responsive to manipulation of the user control.

17. The system of claim 16, wherein the user control comprises one or more of a touch screen, an external keypad, a trackpad, a handheld wireless device, a camera-based facial expression recognition system, a camera-based gesture recognition system, or capacitive sensors configured to recognize at least one of touch or gestures.

18. The system of claim 16, wherein the controller is configured to automatically disable and enable the user control responsive to one or more designated events.

19. The system of claim 1, wherein the display comprises an integrated, rigid, planar support, and wherein in at least one mode of operation the display is at least partially translucent, and wherein the display is received within and attached to an opening of a door panel support, and wherein the predetermined area includes an area within the vehicle in front of the display.

20. A vehicle display system comprising:
a display configured to display diagnostic information associated with a vehicle; and
a controller configured to:
receive at least two diagnostic actuation signals from different sources; and
responsive to receiving the at least two diagnostic actuation signals according to a designated time metric, control the display to show the diagnostic information on the display, wherein the at least two diagnostic actuation signals include two or more of a designated signal received from a user device, a signal received from a sensor indicative of a passenger detected in a predetermined area by the display, or received vehicle operation data that meets designated criteria.
